(19) United States
(12) Patent Application Publication
(10) Pub. No.: US 2008/0257214 A1
(43) Pub. Date: Oct. 23, 2008

(54) Compositions Exhibiting Good Mixing Properties and Use of Silyl Derivatives as Isocyanate Additives, in Particular of Isocyanate Mixture

(76) Inventors: Jean-Marie Bernard, Saint-Laurent D'Agny (FR); Philippe Barbeau, Genas (FR)

Correspondence Address: BUCHANAN, INGERSOLL & ROONEY PC, POST OFFICE BOX 1404, ALEXANDRIA, VA, 22313-1404, US

(21) Appl. No.: 11/794,083

(22) PCT Filed: Dec. 20, 2005
(86) PCT No.: PCT/FR2005/003194

§ 371 Date: Jun. 2, 2008

(30) Foreign Application Priority Data
Dec. 23, 2004 (FR) 0413847

(51) Int. Cl. C09D 5/00; C09K 3/00

(52) U.S. Cl. 106/287.13; 252/183.11; 106/287.1

(57) ABSTRACT

The invention concerns isocyanate compositions exhibiting good mixing properties. The compositions comprise for successive or simultaneous addition: an isocyanate sub-composition comprising by weight not more than 5% of diisocyanate monomers and monomers derived from amino acids and comprising an isocyanate function content not more than 55%; a compound selected among the compounds bearing dihydrocarbylsilylene groups bonded to a metalloid of the chalcogen column or to an atom of the nitrogen column, the content in such groups being not less than 0.1 wt. % expressed in silicon atom weight relative to the amount of monomers corresponding to units derived therefrom. The invention is applicable to the coatings industry, in particular paints and adhesives.

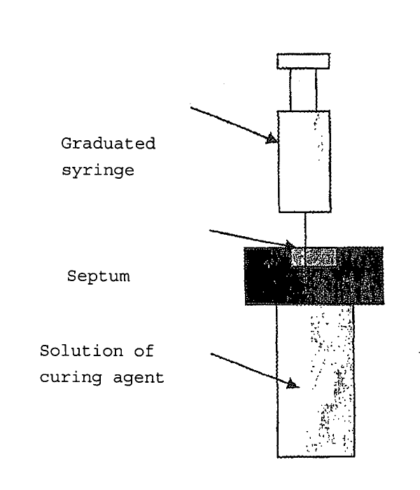

The present invention is targeted at isocyanate compositions exhibiting good mixing properties. It relates more particularly to the use of silylated derivatives as adjuvants, in particular mixing adjuvants, this being in particular to improve the compatibility of the isocyanate compositions with the various solvents used in the field of crosslinking, in particular when such materials are used as components of coatings, in particular paints [more particularly binder(s) of paints and varnishes] and adhesives.

In order to place the present invention in the industrial and semantic context, it is advisable to restate a certain number of points and to specify or recall a certain number of definitions.

Unless otherwise specified, the measurement conditions are those of the SAC (standard ambient conditions, namely temperature θ=25° C.; pressure P=10⁵ Pa). In addition, it may be restated that, in the field of paints and in particular of isocyanates, the viscosities given correspond to a measurement under standard ambient conditions (namely, θ=25° C.; P=10⁵ Pa) carried out according to Standard NF EN ISO 3219 of November 1994 (Method of determination of viscosity by the rotating cylinder method).

Predominantly, polyisocyanate compositions are generally formed from derivatives resulting from the oligocondensation of individual di-, tri-, indeed even tetraisocyanate molecule(s).

Such a type of molecule is described as “monomers” and is capable of being obtained by phosgenation of a di(primary amine), optionally carrying one, indeed even two, other primary amine functional groups. Thus, such a molecule comprises a unit composed of a carbon chain carrying at least two nitrogens (originating from the diamine to be phosgenated), which unit will be denoted by “diamino unit” in the continuation of the description. The diamino unit serves here as vestige or mark of the existence, past or present, of an isocyanate monomer: thus, the diamino unit has the structure:

>N—R—N<

where R represents a hydrocarbon radical, obviously divalent, which is the residue of an isocyanate monomer, after ignoring two isocyanate functional groups. Of course, R does not exhibit any of the functional groups created during oligomerization of an isocyanate functional group, namely the carbamate, urea (including biuret) or allophanate functional groups and those which are mentioned hereinbelow on the occasion of the description of the oligocondensations (including oligomerization). The molecular weight of —R— is, on the one hand, at least equal to 50; advantageously to 80, and, on the other hand, at most equal to 250, advantageously 200, more commonly to 150. R can sometimes comprise another primary “amino” group, indeed even two other primary “amino” groups (which will have been phosgenated during the stage of conversion of the primary amine functional groups). This is the case of the trifunctional monomers, such as LTI, NTI and UTI (or Unti).

The “amino” symbols N< and >N mean that the nitrogen can be inserted into any isocyanate functional group or functional group deriving therefrom, such as isocyanate, amine, amide, imide or urea (including biuret and acylurea) functional group, and in particular the functional groups generated by the oligomerization reactions.

These diamino units are found in virtually all of the oligocondensations and in the vast majority of the conversions of the isocyanate functional groups. This observation makes it possible to refer to the number of diamino units in order to indicate in particular the state of condensation of the monomers and of the oligocondensates (including oligomers), indeed even of the polycondensates, and even in the case of heterocondensates (in which case, it is possible to have several types of diamino units).

According to the usage common in chemistry, when a functional group has given its name to a family of compounds (in other words, when a functional group serves as eponym for a family of products, as is the case for the isocyanates), the aromatic or aliphatic nature is defined according to the point of attachment of the functional group under consideration. When an isocyanate is situated on a carbon of aliphatic nature, then the isocyanate compound is itself considered to be of aliphatic nature. Likewise, when an isocyanate functional group is attached to the backbone via a carbon of aromatic nature, then the whole monomer will be denoted by the expression “aromatic isocyanate”.

To clarify this point, it may be restated that:
any isocyanate functional group having a point of attachment (of the nitrogen, of course) which is a member of an aromatic ring is regarded as aromatic;
any isocyanate functional group having a point of attachment (of the nitrogen, of course) which is a carbon of sp³ hybridization is regarded as aliphatic.

The following distinctions may be made or the following subcategories may be created among aliphatic isocyanates:
any aliphatic isocyanate functional group having a point of attachment separated from the closest ring by at most one carbon (preferably, the point of attachment is on the same ring) is regarded as cycloaliphatic;
any isocyanate functional group having a point of attachment carried by a secondary sp³ carbon (that is to say, a carbon connected to two carbons and to a hydrogen) is regarded as secondary;
any isocyanate functional group having a point of attachment carried by a tertiary sp³ carbon (that is to say, a carbon connected to three carbons) is regarded as tertiary;
any isocyanate functional group having a point of attachment carried by an sp³ carbon itself carried by a tertiary carbon (that is to say, not taking into account the final bond, a carbon connected to three carbons) is regarded as neopentylic;
any isocyanate functional group having a point of attachment carried by a methylene sensu stricto (—CH₂—) is regarded as primary;
any isocyanate functional group having a point of attachment carried by a methylene sensu stricto (—CH₂—) itself carried by an exocyclic and nontertiary sp³ carbon is regarded as linear.

As regards the monomers, the distributing by category can be easily carried out in the following way:

### Thus:

any monomer, all the isocyanate functional groups of which are aliphatic, is said to be aliphatic;
any monomer, all the isocyanate functional groups of which are aromatic, is said to be aromatic;
any monomer, one functional group at least of which is aliphatic and one functional group at least of which is aromatic, is said to be mixed;
any monomer, all the isocyanate functional groups of which are aliphatic and one at least of which is cycloaliphatic, is said to be cycloaliphatic;
any monomer, all the isocyanate functional groups of which are aliphatic, none of which are cycloaliphatic and either one at least of which is linear or which exhibits at least one polymethylene sequence, free in rotation and thus exocyclic, (CH₂)_{π}, where π represents an integer at least equal to 2, is said to be linear aliphatic.

To explain in a little more detail, the isocyanate monomers can be:
aliphatic, including cycloaliphatic and arylaliphatic (or araliphatic), such as:
   as linear (or simple) aliphatic, polymethylene diisocyanate monomers which exhibit one or more exocyclic polymethylene sequences (CH₂)_{π} where π represents an integer from 2 to 10, advantageously from 4 to 8, and in particular hexamethylene diisocyanate, it being possible for one of the methylenes to be substituted by a methyl or ethyl radical, as is the case with MPDI (methylpentamethylene diisocyanate);
   as cyclic aliphatic (or cycloaliphatic), partially “neopentylic” and cycloaliphatic; for example, isophorone diisocyanate (IPDI);
   as cyclic aliphatic (cycloaliphatic) diisocyanate, those derived from norbornane or the hydrogenated forms (hydrogenation of the nucleus of the arylenediamines, resulting in a diaminated ring subsequently subjected to isocyanation, for example by phosgenation) of the aromatic isocyanates, giving, for example, 1,3- or 1,4-BIC (BisIsocyanatomethylCyclohexane);
   as araliphatic, monomers (such as OCN—CH₂-Φ-CH₂—NCO); a portion of which is regarded as linear aliphatic, namely those having the isocyanate functional group separated from the aromatic nuclei by at least two carbons, such as (OCN—[CH₂]ₜ-Φ-[CH₂]ᵤ—NCO) with t and u greater than 1;
or also aromatic, such as toluoylene diisocyanate, mentioned here as a matter of interest.

Generally and preferably, the molecular weight of a monomer does not exceed 300 and is at least equal to 100.

According to the present invention, it is desirable for linear aliphatic monomers to be used at least partially for the implementation of the present invention. To those which are mentioned above can also be added NTI (Nonyl TriIsocyanate OCN—(CH₂)₄—CH(CH₂—NCO)—(CH₂)₃—NCO) or UTI (Undecyl TriIsocyanate OCN—(CH₂)₅—CH(—NCO)—(CH₂)₅—NCO).

In the context of the present invention, amino acid derivatives and in particular lysine derivatives, in particular LDI (Lysine DiIsocyanate, resulting from ester of lysine) or LTI (Lysine TriIsocyanate, resulting from the ester of lysine with ethanolamine), are not targeted as monomers and as units which result therefrom.

The majority of these monomers have a vapor pressure which is too high to meet regulatory requirements relating to safety at work. Consequently, these molecules are increased in size by oligocondensing them (hetero- and homocondensation).

These condensations involve the isocyanate functional groups. As the “monomers” are polyfunctional with regard to isocyanate, these condensations can take place on two or more isocyanate functional groups of the same molecule. It follows that these reactions can result in oligomers which are smaller or bigger in size depending on the degree of conversion of the isocyanates.

The main oligocondensates will be restated below:

The derivatives obtained by “trimerization”, that is to say that three isocyanate functional groups belonging to three different molecules are condensed to form an isocyanuric ring carrying three groups themselves generally carrying an isocyanate functional group.

The main units, functional groups or rings liable to be formed on the occasion of the trimerization may be restated:

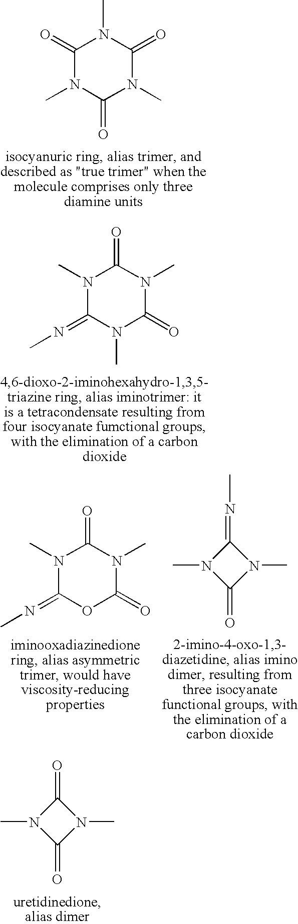

Another way of increasing the size of the molecule is to condense them with one another in the presence of water to form a derived functional group carrying three isocyanate functional groups which is denoted under the expression of biuret functional group or of “biuret”. The reaction below shows the reaction in the commonest case, that is to say the case where the three molecules to be condensed are the same:

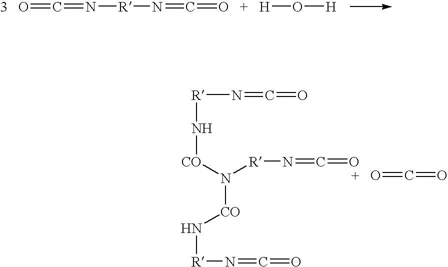

It is also possible to obtain such a structure from an amine carrying at least one hydrogen, see below.

It is also possible to condense these monomers with alcohols, in particular polyols, which gives carbamate and then allophanate polyfunctional compounds.

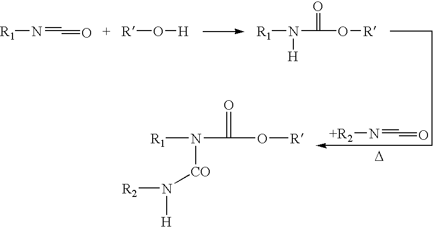

This type of heterocondensation is very general and corresponds essentially to condensations with carriers of a functional group comprising mobile hydrogen, see below and in the book: “Methoden der organischen Chemie Kohlenssäure Derivat”, edited by Hermann Hagemann, 1983, Houben-Weyl, Georg Thieme Verlag, Stuttgart.

Generally, in the polyisocyanate compositions, minor amounts of various condensation types are found, in addition to the predominant polycondensates.

The polyisocyanate compositions which have just been described are generally used as crosslinking agent, in particular in the field of paints, varnishes and adhesives.

The coreactants of these isocyanates are polyfunctional compounds based on functional groups comprising mobile hydrogen (see below).

Generally, these polyfunctional compounds are compounds comprising numerous functional groups, such as alcohol, thiol and/or amine, indeed even carboxylic acid, functional groups; they are generally polyols.

The number-average functionality of these polyfunctional compounds is extremely variable according to what is desired to be obtained. It generally varies from 2 to approximately 20, indeed even 30, and even 40, more generally from 3 to approximately 20; frequently ranging from 4 to 15, often between 5 and 10. Of course, the preceding numbers are values rounded up or down to the closest unit (rule of mathematical rounding); this is because the value may be fractional since this number functionality can be obtained by multiplying the functionality by weight, expressed as equivalent per gram, by the number-average molecular weight (Mₙ).

The commonest functional groups possessing mobile hydrogen are those which are set out below. Generally, the contents of a functional group possessing mobile hydrogen are given as a number (alcohol number, acid number, and the like) which corresponds to an equivalence of potassium hydroxide; in this case, in order to have the number of functional groups per gram, it is sufficient to divide the number, expressed per gram, by the weight of the potassium hydroxide, that is to say by 56 (two significant figures). The content of a functional group possessing mobile hydrogen can be expressed as percentage by weight of the functional group (for example, weight of the ol functional group 17, primary amine functional group 16, thiol functional group 33, carboxylic acid functional group 45, and the like).

Such functional groups possessing mobile hydrogen (recorded below as Ψ-H) exhibit a hydrogen described as mobile and are such that the reaction of the following equation (C1) takes place, optionally followed by the reaction of the equation (C2):

-L-Ψ-H+OCN-→-L-Ψ-C(O)—N(H)— (C1)

-L-Ψ-C(O)—N(H)-+OCN-→-L-Ψ-C(O)—N(C(O)—N(H)—)— (C2)
where L represents the bond with the remainder of the molecule;
where Ψ represents a chalcogen (advantageously oxygen or sulfur) or a trivalent nitrogen or phosphorus, indeed even arsenic and even antimony, atom. Ψ can also represent a carbon carrying a hydrogen rendered mobile by one or more electron-withdrawing groups, an example of which is the malonic carbon.

In the case where the hydrogen, in particular of the hydroxyl, is acidic (pKa at most equal to 6, generally to 5), a subsequent decarboxylation reaction may take place. Thus, the carboxyl functional groups can give, for their part, acylureas (this is because the commonest reaction sequence is as follows: the addition of the isocyanate results in the asymmetric acid anhydride of the carboxylic acid and of the carbamic acid corresponding to the isocyanate; this anhydride decomposes [see reaction (C3)] (in the case where psi (Ψ) is oxygen, it decarboxylates) to give the amide of said carboxylic acid and of the amine corresponding to the isocyanate.

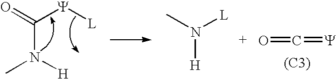

A second isocyanate functional group can then react with the amide (equation of C2 type) to give an acylurea. This reaction explains the formation of urea during the addition of water to isocyanate; the reaction C2 then gives biuret.

Ψ can also represent a nitrogen atom carrying a hydrogen or a hydrocarbon radical (that is to say, comprising hydrogen and carbon) of at most 15 carbon atoms but, in this case, the reaction (3) does not take place.

L is advantageously chosen from the single bond (—), the carbonyl groups [—C(═O)—, including NH₂—C(═O)] or the groups of imino type (>C═N— and —C(═N—)— [for example in order to form amidines, amidoximes (—C(═N—O—H)—NH₂) or a conjugated form of the amides]).

These functional groups are well known to a person skilled in the art and mention may be made, among them, of the functional groups possessing an amino group (where Ψ represents >N—) which, in addition to amines and anilines, comprise amides [where Ψ is preceded by a carbonyl group to give —C(═O)—N<] with, as specific cases, lactams and ureas, functional groups possessing a hydroxyl group [where Ψ represents —O—] which, in addition to alcohol functional groups, including phenols, comprise oxime functional groups [where Ψ is preceded by an imino group to give ═N—O—], oxygen acid with a pKa at least equal to 1, advantageously equal to 2, preferably to 3, in particular carboxylic acid functional groups [where Ψ is preceded by a carbonyl group to give —C(═O)—O—], and thiol functional groups.

The meaning of certain standard terms is restated below:
Bisdimer: oligomer resulting from the condensation of three monomers and exhibiting two uretidinedione units;
Trisdimer: tetramer comprising three uretidinedione units;
Bistrimer: pentamer comprising two isocyanurate units;
Trimer-Dimer: tetramer comprising an isocyanurate unit and comprising a uretidinedione unit;
Trimer-Dimer-Trimer: hexamer comprising two isocyanurate units and comprising a uretidinedione unit.
In the case of a homocondensation, the “heavy products” correspond to the oligomers having a molecular weight equal to or greater than 7 times that of the monomer used.
In the case of a heterooligocondensation (in particular heterooligomerization), the “heavy products” correspond
   in the case of a heterooligomerization (condensation of two or more isocyanate monomers), to the oligocondensates, including the oligomers having at least seven diamino units as defined above, and statistically a molecular weight equal to or greater than 7 times that of the monomers used, weighted by their respective molar proportions: in other words, the weight to be taken into account is the sum of the molecular weights of each monomer multiplied by the respective molar percentage;
   in the case of a heterocondensation (involving isocyanate compounds and compounds possessing mobile hydrogen), to the oligocondensates exhibiting a molecular weight equal to or greater than 7 times that of the monomers used, weighted by their respective molar proportions (in other words, the weight of the sum of the molecular weights of each monomer multiplied by the molar percentage).

The NCO content is usually measured according to the Standard AFNOR NF T 52-132 of September 1988 (sometimes denoted by dibutylamine method).

The determination of the average molecular weight is carried out according to the usual method with regard to isocyanate; the oligomeric composition is subjected to an oligomeric separation technique, such as chromatographic separation by gel permeation; in this way, several oligomeric fractions are obtained, the various components of which will be identified by structural analysis, in particular infrared analysis (optionally complemented by other techniques known in the field, such as NMR).

In a second step, the distribution and the functionality of these components are determined, generally by using their spectral properties, in particular the bands characteristic of polyisocyanate compounds, such as the bands of the isocyanate functional groups and of the functional groups (of course, including rings) which result therefrom. Thus, the alkyl bands and the CO bands of the condensation functional groups, such as isocyanurate, urethane, allophanate and uretidinedione, are widely used to do this. An oligomeric distribution by weight corresponding to each synthesis exemplified is thus accessible.

For each oligomeric fraction, for each oligomer isolated, an overall functionality is measured expressed by the content of NCO functional group (percentage by weight or equivalent per gram) which, by comparison with the theoretical values of the pure oligomers, can give an excellent indication with regard to the structure and with regard to the distribution of the components of an oligomeric fraction (thus, in the case of an oligomeric fraction corresponding to a trimerization, the fact that the HDI bisdimer has a functionality of 2 and a content by weight of isocyanate of 16.67%, while the true trimer exhibits a functionality of 3 and a content by weight of 25%, makes it possible to get a precise idea of the distribution between these two isomers so long as the isocyanate content of the oligomeric fraction corresponding to a trimer is known).

It should be remembered that, in this field, the mean functionality is obtained in the following way: the percentage by weight of each oligomer or each oligomeric fraction of the composition is multiplied by its own functionality and then the functionalities contributed by each oligomer are added up. The total represents the mean functionality of the oligomeric composition. In the case of the present invention, the final compositions are subjected to separation on an assembly of gel permeation columns sold by Polymer Laboratories under the brand PL Gel type mixed E.

This crosslinking reaction by the action of the isocyanate functional groups on the coreactants possessing mobile hydrogen mentioned above is generally carried out in solvents, this being the case although the amount of solvent has been significantly reduced in recent years due to the increasingly strict regulations with regard to solvents.

The various coreactants, the various additional components and especially the various solvents may comprise impurities which give harmful reactions with the polyisocyanates.

Among these impurities, those which exhibit functional groups possessing mobile hydrogen are liable to be detrimental, one of the awkward impurities being the water present in the additional components and in the solvents.

In the latter case, this is particularly marked in polar solvents (see Vogel's Textbook of Production Organic 5^{th} edition Amedis 5, page 1442). The problem is marked for solvents having a donor number of at least equal to 5 and even more marked for those having a donor number of at least equal to 10.

The solvents capable of dissolving at least 0.5% by weight of water under the SAC (standard ambient conditions, namely 25° C.; 10⁵ Pa) and more again those capable of dissolving 1%, especially those capable of dissolving at least 2%, are particularly affected by this issue.

The hydrolysis reactions are particularly harmful when the water is dissolved in an additional component and especially in a solvent. Furthermore, the content of isocyanate functional group decreases. This is because everything happens as if the access to the isocyanate functional groups were promoted by the existence of third solvents between water and the isocyanates.

This hydrolysis reaction is awkward on two accounts: first, there is release of carbon dioxide gas and, secondly, a risk of formation of urea.

Among the equations which can be envisaged, the most plausible are detailed below but they constitute only a possibility.

### Hydrolysis

The reaction H1 below is an absorption of water by the isocyanate functional group, the reaction denoted by H2 (see below) results in the formation of carbon dioxide gas and the equation H3 results in the formation of urea, which causes problems and can cause trouble for the possible coatings.

It is for this reason that it is desirable to find a technique which makes it possible to prevent either the equation No. H1 or the equation No. H2 of these hydrolysis reactions.

The reaction H3 below constitutes the first stage of a process which, first, increases the viscosity and, secondly, results in a biuret functional group.

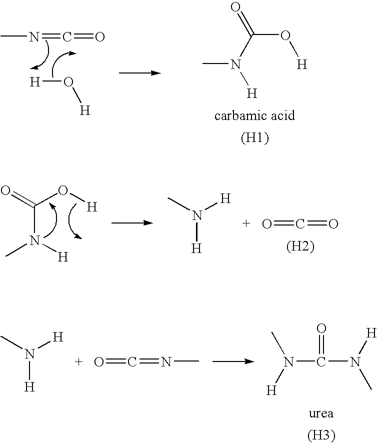

The release of carbon dioxide gas is an additional disadvantage in storage as, if the isocyanate compositions take up moisture, then there is a risk of excessive pressure in, indeed even of explosion of, the containers comprising the isocyanate compositions.

Appeal to a conventional dehydrating agents is inadequate as the isocyanate functional group is itself extremely avid for water and is frequently used as water absorber.

This is why one of the aims of the present invention is to find a reactant which is capable of preventing the formation of carbon dioxide gas and the formation of insoluble urea by the action of the moisture present or potentially present in poorly dehydrated components on the isocyanate functional groups.

Another aim of the present invention is to provide a technique which can be used for isocyanate functional groups of aliphatic nature and thus for aliphatic monomers, their mixtures and even for the mixture of aliphatic and aromatic monomers.

Another aim of the present invention is to provide a technique which makes it possible to facilitate the mixing of isocyanate compositions with solvents of standard grade not recommended for use with isocyanates and not dehydrated beforehand, without harming the storability of said isocyanate compositions, in particular those obtained after, or by, mixing with a solvent of hygroscopic nature.

Another aim of the present invention is to provide isocyanate compositions which exhibit good resistance to moisture and which make it possible, ipso facto, to withstand, without damage, frequent opening and closing of the container comprising said isocyanates without this involving the taking of restrictive precautions (as is in particular the case in the painting business after automobile repair).

These aims and others which will become apparent subsequently are achieved by means of a composition, characterized in that it comprises, for successive or simultaneous addition:

an isocyanate subcomposition:
comprising, by weight, only at most 5%, advantageously only at most 2%, preferably only at most 1%, more preferably at most 0.5%, of monomers carrying at most two isocyanate functional groups and/or of monomers resulting from amino acids and
comprising a content of isocyanate functional group at most equal to 50%, advantageously to 40% (MW by weight of NCO=42);
characterized in that it additionally comprises at least one compound chosen from compounds carrying dihydrocarbylsilylene [-(Hc)₂Si—] group(s), indeed even hydrocarbyl(hydrocarbyloxy)silylene [-(Hc)-(Hc-O—)Si—] group(s), attached to a semimetal of the chalcogens column or of the nitrogen column, the content of such group(s) being at least equal to 0.1‰ (by weight), advantageously at least to 1‰ and at most to 3%, expressed as weight of silicon atom (A.W.=28.1) corresponding to the definition with respect to the amount of monomers corresponding to the units which result therefrom.
The formulae [-(Hc)₂Si—] hydrocarbyl(hydrocarbyloxy)-silylene [-(Hc)(Hc-O—)Si—] can be written in the following shared way [-(Hc)(Hc-{O}_{ν}—)Si—], with ν having the value zero or one (cardinal number). In this formula, the two Hc groups can be identical or different.
The preferred value of ν is zero.
Of course, although this is not preferred, said subcomposition can be used with conventional dehydrating agents.

Advantageously, said dihydrocarbylsilylene [-(Hc)₂Si—] groups are trihydrocarbylsilyl [(Hc)₃Si—] radicals.

Thus, the content of silicon atoms which is targeted above should be understood as the weight of silicon atoms which meet the two-fold constraint of being, first, part of a silylene unit and, secondly, connected to a chalcogen atom (within the broad sense comprising in particular oxygen, sulfur or selenium) or to an atom of column V of the Periodic Table of the Elements, namely the nitrogen column, with respect to the amount of monomers corresponding to the units which result therefrom.

In addition, these chalcogen atoms or atoms of column V must be semimetals, which excludes the heaviest elements of the column of the chalcogens and of column V.

In the above formula, the Hc group or groups represent(s) hydrocarbyl groups (that is to say, comprising both hydrogen and carbon, which hydrocarbyl groups can be identical or different; the atom connecting the Hc radical to the remainder of the molecule being a carbon atom). These hydrocarbyl groups, recorded as Hc, advantageously exhibit a relatively low weight, in order to avoid constituting an excessively large part by weight of the isocyanate compositions, while having a capacity for stabilization, indeed even for signification dessication.

Thus, it is desirable for Hc to exhibit at most 15 carbon atoms, advantageously at most 10 carbon atoms, preferably at most 6, more preferably at most 4.

The hydrocarbyls are chosen in particular from aryls and alkyls. In the latter case, they advantageously represent the methyl, ethyl, propyl, indeed even butyl groups.

The term alkyl, which encompasses aralkyls, is taken from an alkyl alcohol from which the alcohol part (that is to say, hydroxyl [—OH]) has been removed. It is thus a radical, the open bond of which is carried by an sp³ carbon itself carrying only carbon-hydrogen or carbon-carbon bonds.

The dihydrocarbylsilylene [-(Hc)₂Si—] groups, indeed even hydrocarbyl (hydrocarbyloxy) silylene [-(Hc)(Hc-O—)—Si—] group(s), are divalent and it is highly desirable for at least one of the two nonspecified bonds to be attached to a semimetal chosen from those of the column of the chalcogens (in particular sulfur or oxygen), advantageously from those of the nitrogen column, preferably nitrogen, indeed even phosphorus. These dihydrocarbylsilylene [-(Hc)₂Si—] groups can also be such that the two unspecified bonds in the formula [-(Hc)₂Si—] are each connected to an identical or different semimetal chosen from those of the column of the chalcogens (in particular sulfur or oxygen), advantageously from those of the nitrogen column, preferably nitrogen, indeed even phosphorus.

These dihydrocarbylsilylene [-(Hc)₂Si—] groups advantageously belong siloxanyl radicals (siloxane, one bond of which with the silicon remains free), silazanyl radicals (silazane, one bond of which with the silicon remains free), silanyl radicals, in particular trihydrocarbylsilyl [—Si(Hc)₃] radicals (that is to say, in the sense of the present description, a silanyl comprising only a single silicon), with the general preferred values mentioned above.

More specifically, the dihydrocarbylsilylene groups are of [-(Hc)(Hc′)Si—] form and the trihydrocarbylsilyls are of [—Si(Hc)(Hc′)(Hc″)] form;

with:
Hc independently represents a hydrocarbyl group (that is to say, comprising both hydrogen and carbon) of at most 15 carbon atoms, advantageously at most 10 carbon atoms, preferably at most 6, more preferably at most 4. The hydrocarbyls are chosen in particular from aryls and alkyls. In the latter case, they advantageously represent the methyl, ethyl, propyl, indeed even butyl, groups;
Hc′ independently represents a hydrocarbyl group (that is to say, comprising both hydrogen and carbon) of at most 15 carbon atoms, advantageously at most 10 carbon atoms, preferably at most 6, more preferably at most 4. The hydrocarbyls are chosen in particular from aryls and alkyls. In the latter case, they advantageously represent the methyl, ethyl, propyl, indeed even butyl, groups;
Hc″ independently represents a hydrocarbyl group (that is to say, comprising both hydrogen and carbon) of at most 15 carbon atoms, advantageously at most 10 carbon atoms, preferably at most 6, more preferably at most 4. The hydrocarbyls are chosen in particular from aryls and alkyls. In the latter case, they advantageously represent the methyl, ethyl, propyl, indeed even butyl, groups.

Advantageously, the dihydrocarbylsilylene groups exhibit at most 8, preferably at most 7, more preferably at most 4, carbon atoms.

It is desirable for the trihydrocarbylsilyls to exhibit at most 10, preferably at most 9, more preferably at most 6, carbon atoms.

These dihydrocarbylsilylene groups can constitute a member of a ring.

Thus, among the compounds giving good results, it is possible to report the compounds carrying dihydrocarbylsilylene groups of formula:

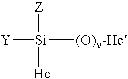

where ν represents zero or 1, advantageously zero;
in which formula Y represents:
an amino group, optionally mono or substituted by one or two identical or different substituents chosen from:
   residues of oxygen acids (such as the following acids: carboxylic, hydrocarbyl sulfuric, sulfonic, sulfinic, phosphoric and their di- and monoesters, phosphonic and their monoesters, phosphinic, and the like) after elimination of a hydroxyl group and thus giving, with Y, amides (carboxamide, sulfonamide, phosphoramide, and the like), in particular acyls (including the acids derived from carbonic acid, such as carbamyls);
   hydrocarbyls, in particular alkyls and aryls;
   trihydrocarbylsilyls;
   groups or radicals of formula

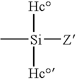

in which Z′, Hc^{o} and Hc^{o}′ exhibit the same definitions as Z, Hc and Hc′ respectively;
a light chalcogen (selenium, sulfur or advantageously oxygen) carrying a substituent chosen from:
   residues of oxygen acids (such as the following acids: carboxylic, hydrocarbyl sulfuric, sulfonic, sulfinic, phosphoric and their di- and monoesters, phosphonic and their monoesters, phosphinic, and the like) after elimination of a hydroxyl group and thus giving, with Y, amides (carboxamide, sulfonamide, phosphoramide, and the like), in particular acyls (including the acids derived from carbonic acid, such as carbamyls);
   if need be, hydrocarbyls, in particular alkyls and aryls;
      Z is chosen from:
the same values as Y;
a hydrocarbyl, in particular alkyls and aryls;
silanoxanyls;
silazanyls;
if need be, silanyls;
   Y and Z can be connected to one another to form a ring, of which the dihydrocarbylsilylene [-(Hc)₂Si—] group is a member;
   Hc and Hc′ have already been defined (see above).

It should be remembered that, advantageously, the dihydrocarbylsilylene groups exhibit at most 8, preferably at most 7, more preferably at most 4, carbon atoms.

It is desirable for the trihydrocarbylsilyls to exhibit at most 10, preferably at most 9, more preferably at most 6, carbon atoms.

The preferred compounds are nitrogeneous compounds, that is to say the dihydrocarbylsilylene group of which is attached to a nitrogen atom, in particular when Y is nitrogen.

However, when the semimetal atom connected to the dihydrocarbylsilylene group is a chalcogen χ (chi) (for example, when Y is a chalcogen, including oxygene), it is desirable for the set of the Y group connected to the silicon atom of the dihydrocarbylsilylene group to constitute a good leaving group. This can be indicated and quantified by indicating that, when said semimetal is a chalcogen, the latter is attached to an electron-withdrawing group such that this electron-withdrawing (Ew) group is such that Ew-χ-H, and in particular Ew-O—H, is an acid, the pKa of which, measured in water, is at most equal to 9, advantageously to 6, preferably to 4, more preferably to 2.

This is particularly true in the case where said semimetal is an oxygen.

The pKa values indicated above are values corresponding to a mathematical rounding, that is to say, in the specific case above, to an uncertainty of 0.5 pKa unit.

The stronger the acid, the better generally the ability to silylate. This is the reason why it is preferable to use, as silylating agent, derivatives of relatively strong acids.

When the silylating agent is an agent in which all the dihydrocarbylsilylene groups are connected to a chalcogen, it is preferable to add an organic or inorganic base to the medium in order to neutralize the possible acid released by the reaction, in particular by the dehydration, a base thus capable of constituting by salification of forming a counter cation to the acid generated.

Thus, when said semimetal (in particular Y) is a chalcogen -χ- and when the latter chalcogen is attached to an electron-withdrawing group such that Ew-χ-H is an acid, the pKa of which, measured in water, is at most equal to 8, advantageously to 6, the composition comprises a nonalkylatable organic or inorganic base capable of neutralizing said acid.

The preferred bases are relatively weak bases, so that these bases do not bring about polycondensation of the isocyanate functional groups. In addition, it is highly preferable for these bases not to react either with the isocyanate (—NCO) functional groups. Thus, it is preferable for the pKa of the acid associated with the base to be at most equal to 12, advantageously to 11, preferably to 10.

The preferred bases are tertiary amines, indeed even tertiary phosphines (with the proviso that they are soft, trialkylphosphines, which are themselves hard, generally being catalysts of di- and trimerization), which are at least partially aromatic, namely mono-, di- or triaromatic (mono-, di- or triaryl).

It is preferable for, in the above case, that is to say when the silylating agent is a silanyl ester and when the corresponding acid exhibits a pKa, measured in water, at most equal to 8, advantageously to 6, the composition to comprise a nonalkylatable base in an amount at least equal, expressed in normality, to 0.1, advantageously 0.2, preferably to 0.5, times the amount of hydrocarbylsilylene grafted to acid functional groups defined by the above pKa, expressed as silicon atom equivalents.

It is also preferable for this amount of base to be at most equal, expressed in normality, to twice, advantageously 1.5 times, the amount of hydrocarbylsilylene as defined above, expressed as silicon atom equivalent.

In other words, it is a question of neutralizing the possible acid functional groups given off by the silylating agent during the silylation which occurs either with water or with the hydrolysis products of the reaction mixture which the isocyanate composition constitutes when water or solvents or additives not completely dehydrated are introduced.

According to the present invention, the isocyanate composition can comprise a solvent for successive or simultaneous addition and is particularly advantageous when this solvent is not completely dehydrated. Dehydration occurs during the mixing and in the period immediately subsequent to the mixing. Solvents comprising, by weight, from 0.5‰ to 2% of water, in particular from 1‰ to 2%, are regarded as poorly dehydrated solvents.

The invention is more suited to the case where the [water/(solvent+isocyanate subcomposition)] ratio by weight is within a closed range (that is to say, comprising the limits) ranging from 0.3‰ to 1%, in particular from 0.5‰ to 1%.

Of course, the present invention is particularly advantageous in the case of the use of a hygroscopic solvent and/or of a solvent having a high affinity for water, in particular solvents capable of dissolving by weight (more precisely of being miscible with) at least 5%, advantageously 10%, of their weight of water.

The isocyanate composition can also comprise, for successive or simultaneous addition, a surface-active agent. This surface-active agent can in particular be an agent in an amount and of a nature such that the isocyanate composition is emulsified during vigorous or gentle stirring in an aqueous phase.

It is appropriate to mention, among particularly advantageous surface-active agents, surface-active agents obtained by grafting to the isocyanate by a molecule exhibiting polyalkylene oxide groups, in particular polyethylene oxide groups. This can be carried out by condensation(s) between an isocyanate functional group and a polyethylene oxide, at least one of the two ends of which carries a functional group possessing mobile hydrogen, in particular an alcohol or an amine functional group (such as, for example, the Jefferson amines, alias Jeffamine).

It is also appropriate to mention the condensations between one, indeed even several, isocyanate functional group(s) and salts of organic acids [if appropriate, at least partially in the salt form when the decarboxylation (C3) is regarded as untimely and if it is desired to avoid it] carrying at least one (and at most three) functional group(s) possessing mobile hydrogen. Mention may be made, as examples of such acids, of alcohol acids and amino acids. The corresponding anions constitute valuable surface-active agents. The cocations are chosen from the same lists as those of the preferred surfactants of formula (I).

However, particular mention must be made of surface-active agents comprising, as main constituent, a compound or mixture of compounds of general formula (I):

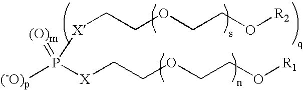

where:
p represents an integer between 1 and 2 (closed ranges, that is to say comprising the limits);
m represents zero or, advantageously, 1;
the sum p+m+q is at most equal to 3;
the sum 1+p+2 m+q is equal to 3 or 5, advantageously to 5;
X is an oxygen or a single bond;
X′ is an oxygen or a single bond;
n and s, which are identical or different, represent an integer chosen from those at least equal to 2, advantageously to 3; preferably to 4, more preferably to 5 and at most equal to 30, advantageously to 25; preferably to 20, more preferably to 9; and the preferred ranges are between 3 and 25, advantageously between 5 and 20, preferably between 5 and 9 (closed ranges, that is to say comprising the limits);
where R₁ and R₂, which are different or, advantageously, identical, are chosen from radicals of aliphatic nature (that is to say that their open bond is carried by a carbon of sp³ hybridization of 8 to 20 carbon atoms) and without an aromatic nucleus, which are optionally substituted, advantageously alkyls, with the exclusion of aralkyls.

R₁ and R₂ generally represent an alkyl, optionally and advantageously branched, of 8 to 20 carbon atoms. Mixtures of alkyls resulting from mixtures of alcohols (generally a mixture of isomers), such as the product sold under the name of isotridecyl alcohol, are often involved.

The integer q thus represents 1 or zero.

For s and n, a choice within the range extending from 9 to 20 can also be advantageous when the cocations are highly soluble (alkali metals, optionally sequestered, quaternary ammoniums or phosphoniums, tertiary amines of low molecular weight, that is to say of at most 7 carbon atoms); advantageously, one of the X and X′ groups is oxygen, preferably both are oxygen. For further details on the cocations, reference may be made to the relevant passages of the present description.

It is preferable for, in the case of a mixture of compounds of formula (I), the majority of them in moles to correspond to the formula (I) with “q” having a value of zero to give the formula (II):

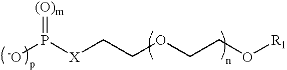

with:
“m” being equal to zero or 1, preferably 1;
“p” having the value 2.

When a mixture of compounds is used, as is preferred, the values, which are whole values for a defined molecule, become values which may then be fractional.

Thus, in the formula (I), q, p (indeed even m, but this is not preferred due to difficulties in synthesis, products of two different syntheses which have to be mixed: phosphite and phosphate) and in particular n and s become statistical values (by number, although this makes scarcely any difference, it being possible for the number of molecules of formula (I) then to be easily determined by pHmetry, see below).

The diester to monoester statistical ratio (that is to say, q) is advantageously at most equal to ¾, advantageously to ⅔, preferably to ½ and even less (see below).

The emulsifiable composition then becomes an emulsifiable isocyanate composition advantageously comprising:
an isocyanate composition with a content by weight of N═C═O functional group of between 15 and 25% and with a viscosity at most equal to 2500 mPa·s, advantageously to 1500 mPa·s, preferably to more 1400 mPa·s, preferentially 1200 mPa·s;
a surface-active agent comprising, as main constituent, a compound or a mixture of compounds of mean general formula:

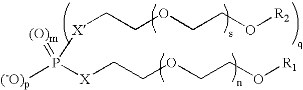

where:
p represents a value between 1 and 2 (closed ranges, that is to say comprising the limits);
m represents zero or 1, advantageously 1;
the sum p+m+q is equal to 3;
the sum 1+p+2m+q is equal to the valency of the phosphorus, that is to say to 3 or to 5, advantageously to 5;
X is an oxygen;
X′ is an oxygen;
n and s advantageously have the same statistical value; n and s, which are identical or different, represent a statistical value chosen from those at least equal to 2, advantageously to 3; preferably to 4, more preferably to 5 and at most equal to 30, advantageously to 25; preferably to 20, more preferably to 9; and the preferred ranges are between 3 and 25, advantageously between 5 and 20, preferably between 5 and 9 (closed ranges, that is to say including the limits);
where R₁ and R₂, which are different or, advantageously, identical, are chosen from radicals of aliphatic or araliphatic nature which are optionally substituted, advantageously alkyls, or acyls, optionally of acrylic nature.

The value q represents a value chosen within the closed range extending from 0 to 1.

For s and n, a choice within the range from 9 to 20 can also be advantageous when the cocations are very soluble (alkali metals, optionally sequestered, quaternary ammoniums or phosphoniums, tertiary amines of low molecular weight, that is to say of at most 7 carbon atoms); alkyl is taken in its sense of an alkyl alcohol from which an OH functional group has been removed. R₁ and R₂ generally represent an alkyl, optionally and advantageously branched, ranging from 8 to 20 carbon atoms (whole or statistical value), preferably from 10 to 15 carbon atoms, more preferably comprising only hydrogen and carbon. It is desirable for R₁ and even R₂ to be alkyl within the meaning of the IUPAC, that is to say corresponding to an alkane, optionally cyclic, from which a hydrogen has been removed.

It should be noted that the statistical ratio “q”, which is chosen within the closed range extending from 0 to 1, is easily determined by acid/base assaying.

It is then desirable for statistical “q” to be at most equal to 0.5, advantageously to 0.3, preferably to 0.2.

In this case, the mean formula is by number (total number of each type of unit or atom divided by the number of molecules), the proportions of each molecule being measured by liquid chromatography, if appropriate, for heavy molecules, by gel permeation.

These compounds are capable of being obtained by partial esterification of phosphorus-comprising acids, advantageously phosphoric acids, by polyethylene oxides (comprising s and n units) terminated by an alcohol functional group and started by an alcohol (R₁ and/or R₂).

The ratio by weight of, on the one hand, said compounds of formula (I) (numerator) to, on the other hand, the isocyanates to be put into suspension is generally at most equal to approximately 0.1, advantageously to 0.10. In the present description, the term “approximately” is employed solely to underline the fact that the values given correspond to mathematical rounding and that, when the figure or figures furthest to the right of a number are zero, these zeros are positional zeros and not significant figures, unless, of course, they are specified to be otherwise.

The ratio by weight of the compounds of formula (I) (numerator) to the isocyanates to be put into suspension (denominator) is advantageously greater than 1%, preferably than 2%.

The self-emulsifiable nature, which constitutes an advantage in these uses, appears from a ratio by weight of approximately 3% in the presence emulsifying compound of other types (themselves in an amount at least equal to 3%) and of approximately 5% when the compounds of formula (I) represent at least 90% by weight of the combined surfactants used as emulsifier.

The coreactants used with the isocyanate according to the invention are often marketed with their own surface-active agents, so that, when the isocyanate composition of the invention is emulsified in the aqueous phase of the coreactant, there may be a self-emulsion, whereas the amount of surface-active agent of formula (I) is inadequate to provide the self-emulsion in pure water. According to the present invention, this compatibility with the surfactants used with the polyols is of great advantage for the implementation of the invention.

It is also desirable for the amount of said compound or compounds of formula (I) to correspond to a value of between 10⁻² and 1, advantageously between 5×10⁻² and 0.5, phosphorus atom per liter.

Thus, the ratio by weight of, on the one hand, the compounds of formula (I) (numerator) to, on the other hand, the isocyanates to be suspended (denominator) is advantageously at least equal to 2%, preferably to 4%, and at most equal to approximately 15%, preferably to 10%; thus, this ratio by weight is advantageously between approximately 2 and 15%, preferably between approximately 4% and 10% (2 significant figures); these ranges are closed, that is to say that they comprise the limits.

According to the present invention, said compounds can be used alone or as a mixture with one or more surface-active agents.

These optional surface-active agents can also be chosen from other ionic compounds [in particular alkyl sulfate or phosphate, alkylphosphonate, alkylphosphinate, alkylsulfonate, fatty acid salt and/or zwitterionic salt] and from nonionic compounds, those blocked at the chain end or not. However, nonionic compounds exhibiting alcohol functional groups on at least one of the chains appear to have a slightly unfavorable effect on the (self)emulsion, even if they have a favorable effect with regard to other aspects of the composition; in view of this, it is preferable for the content of this type of compound to represent at most ⅓, advantageously at most ⅕, preferably at most 1/10, by weight of said anionic compounds according to the invention.

The countercation (or countercations) which provide the electric neutrality of the anionic surface-active compounds (such as those of formula (I)) targeted by the present invention is advantageously monovalent and is chosen from inorganic cations and organic cations which are advantageously nonnucleophilic and consequently of quaternary or tertiary nature [in particular “oniums” of column V, such as phosphoniums or ammoniums (including protonated amines), indeed even of column VI, such as sulfonium, and the like] and their mixtures, most often ammoniums, generally resulting from an amine, advantageously a tertiary amine. Advantageously, the organic cation is prevented from exhibiting a hydrogen which reacts with the isocyanate functional group, hence the preference with regard to tertiary amines.

The inorganic cations can be sequestered by phase transfer agents, such as crown ethers.

The pKa in water of the cations resulting from the protonation of the neutral (organic [ammonium, and the like] or inorganic) bases is advantageously at least equal to 7, preferably to 8, and at most equal to 14, preferably to 12, more preferably to 10.

The cations and in particular the amines corresponding to the ammoniums (protonated amines in this case) advantageously do not exhibit surface-active properties but it is desirable for them to exhibit a good solubility, in any case a solubility sufficient to ensure that of said compounds exhibiting a functional group and a polyoxygenated chain, in the aqueous phase, this being the case at the concentration of use.

Tertiary amines, quaternary ammoniums or phosphoniums exhibiting at most 16 carbon atoms, advantageously 12 carbon atoms, preferably at most 10 carbon atoms, more preferably at most 8 carbon atoms, per “onium” functional group (very obviously including the ammoniums resulting from a tertiary amine by protonation) are preferred; it should be remembered that it is preferable for there to be only one functional group per molecule.

Tertiary amines, quaternary ammoniums or phosphoniums exhibiting at least 4 carbon atoms, advantageously at least 5 carbon atoms, preferably at least 6 carbon atoms, more preferably at least 7 carbon atoms, per “onium” functional group (very obviously including the ammoniums resulting from a tertiary amine by protonation) are preferred.

According to the above, it appears that the preferred bases are tertiary monoamines, and even monophosphines, exhibiting from 6 to 10 carbon atoms, advantageously 7 or 8 carbon atoms.

According to the present invention, it is preferable for one of the substituents of the nitrogen or of the phosphorus to be a secondary, indeed even tertiary, radical, advantageously a cycloalkyl with at most 7 ring members, advantageously 5 or 6 ring members.

The amines can comprise other functional groups and in particular the functional groups corresponding to the functional groups of amino acids and to cyclic ether functional groups, such as N-methylmorpholine, or noncyclic ether functional groups. These other functional groups are advantageously in a form which does not react with the isocyanate functional groups and does not significantly detrimentally affect the solubility in the aqueous phase.

It is highly desirable for the anionic surface-active compounds, in particular according to the formula (I), to be in a neutralized form such that the pH which it brings about when dissolved or brought into contact in water is at least equal to 3, advantageously to 4, preferably to 5, and at most equal to 12, advantageously to 11, preferably to 10.

Thus, it is preferable for only the strong or moderate acid functional groups (that is to say, the pKa of which is at most equal to 4) to be neutralized when there are more than one of them. Weak acidities, that is to say for which the pKa is at least equal to 5, can be partially neutralized.

As is mentioned more generally above, it is preferable for the compounds where “q” is equal to 0 to be greatly predominant. Thus, when the phosphorus is a phosphorus(V) (that is to say, 2m+p+q=5) and when the compounds of the mixture are esters, it is desirable to use mixtures of monoester(s) and of diester(s) in a monoester(s)/diester(s) molar ratio of greater than 2, advantageously than 3, preferably than 4, more preferably than 5, indeed even than 10.

The emulsifying agents according to the invention, in particular the above mixtures, can additionally comprise from 1% up to approximately 20% (however, it is preferable from this not to exceed approximately 10%) by weight of phosphoric acid and/or phosphorous acid (which will advantageously be at least partially salified so as to be within the recommended pH regions) and from 0 to 5% of esters of pyrophosphoric acid. While technically the presence of phosphorous acid is possible, some of its derivatives, in particular silylated derivatives, are reputed to be toxic; it is therefore sensible to avoid this acid, in particular in the cases where there is a risk of it forming derivatives reputed to be toxic.

It is appropriate to point out that the anionic surface-active derivatives defined above, in particular of formula (I), are capable of being silylated and the silylated product comes (if it meets the conditions recommended in the present description) within the category of silylating agents. This is particularly true in the case of the surfactants, the acid form of which corresponds to a moderate or strong acid (pKa≦4.5; advantageously 3, preferably 2).

The present invention can be implemented not only by directly adding the dehydrating agents comprising dihydrocarbylsilylene groups, indeed even comprising hydrocarbyl(hydrocarbyloxy)silylene [-(Hc)(Hc-O—)Si—] group(s) to the isocyanate composition but also by adding the dehydrating and silylating agent in the solvent to the polyisocyanate composition or solution. The solvents which are liable for such a treatment are essentially, as is indicated above, hygroscopic solvents and in particular those which comprise a polar functional group in their formula.

The present invention is also targeted at the use of compounds carrying dihydrocarbylsilylene groups attached to a semimetal of the column of the chalcogens or an atom of the nitrogen column as mixing adjuvant.

These compounds carrying dihydrocarbylsilylene groups are compounds capable of acting as silylating agent and/or as dehydrating agent.

It should be noted that these compounds, in particular the preferred compounds, that is to say those in which the silicon atom is bonded to the nitrogen atom, are derivatives which are known as trimerization agents capable of forming isocyanurate groups from isocyanate functional groups. It is therefore particularly surprising that these compounds can be used as mixing adjuvant without this significantly influencing the storability of the isocyanate compositions.

The present invention is also targeted at an organic phase comprising or composed of the composition according to the present invention.

The present invention is also targeted at a phase as defined above dispersed in a continuous aqueous phase.

The following nonlimiting examples illustrate the invention.

### Composition Formed of Isocyanate Curing Agents

The composition formed of isocyanate curing agents used in this study is as follows:
methoxypropyl acetate (MPA): 55% by weight added at the last moment and resulting in the presence of 500 ppm of water;
the hydrophilic polyisocyanate, the composition of which is as follows:
   4.66% phosphate esterified by a polyethoxylated alcohol comprising 13 carbon atoms and 6 ethylene oxide units; mono*/di ratio 70/30
   4.66% phosphate esterified by a polyethoxylated alcohol comprising 8 ethylene oxide units; mono*/di ratio 70/30 4.66%; 4% nonionic
   dimethylcyclohexylamine (DMCHA): 2.22%
   q.s. for 100% isocyanate composition based on HDI of low viscosity and exhibiting a ratio of the true trimer to the total weight of 0.6 (mathematical rounding):
      NCO 23%
      viscosity (SAC) 600 mPa·s
      equivalent weight 183
      100% solids content
      functionality 3.25

The assaying of the water (by Karl-Fischer) shows that the curing agent composition comprises, on average, 0.5‰ by weight.

### Structures of the Dehydrating Agents

The dehydrating agents studied are:
oxazoline comparative structures (Incozol 2 from Industrial Copolymer)
silylated structures
   bistrimethylsilylacetamide (BSA)
   bistrimethylsilylurea (BSU)
   hexamethyldisilazane (HMDZ)
   trimethylsilyl phosphate (TMSP)

The chemical structures of the various compounds and their physical characteristics are recalled in table I.

### Table I

### Characteristics of the Various Dehydrating Agents Studied

TABLE I
Characteristics of the various dehydrating
agents studied

| | | Molar | |
|---|---|---|---|
| | Chemical | mass | Physical |
| Name of the product | structure | (g/mol) | form |
| Incozol 2 | 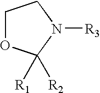 | 114(molareq.) | liquid |
| bistrimethylsilyl-acetamide (BSA) | 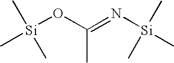 | 203 | liquid |
| bistrimethylsilylurea(BSU) | 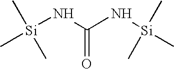 | 204 | powder |
| hexamethyldisilazane(HMDZ) | 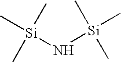 | 161 | liquid |
| trimethylsilyl phosphate(TMSP) | 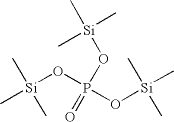 | 314 | powder |

All the silylated products were supplied by Aldrich

### Compositions of the Mixtures

The compositions of the formulations studied in order to demonstrate the performance of the various structures are given in table II below. Mixtures 3 to 10 were formulated with the addition of dehydrating agents while taking into account the 500 ppm added during the addition of the acetate initially to mixture 1 before further addition of water. In all cases, the water added is added last (i.e., after introduction of dehydrating agents) so as to avoid any reaction with the NCO functional groups.

Mixtures 8 and 11 spent 30 min in an ultrasonic bath in order to ensure the dissolution of the products BSU and TMSP.

### Monitoring of the Evolution of Gas

The monitoring of the evolution of gas in the presence or absence of the dehydrating agents was carried out by measuring, using a graduated syringe, the volume of gas produced by 27 g of solution in a flask closed using a septum; however, the isocyanate composition is maintained at 40° C. The measurement is carried out daily. After perforation by the syringe in order to quantify the volume of gas given off, the septum is replaced by a new septum. The scheme of the appended figure describes the principle.

### Results

### Table III

### Isocyanate Formulations Studied

TABLE III
Isocyanate formulations studied

| | | | | | | | Results: existence of an evolution of | | |
|---|---|---|---|---|---|---|---|---|---|
| Reference and distinctive components added to the mixture, as % by | | | | | | | gas (ev), measured total volume given | | |
| weight | | | | | | | off (vg) and observation | | |
| | Level of | | | | | | | | Observation of the |
| Ref. | water | Incozol 2 | BSA | BSU | HMDZ | TMSP | (ev) | (vg) | liquid |
| 1* | 0.05 | | | | | | no | | Slight turbidity |
| | | | | | | | | | after 21 d at 40° C. |
| 2* | 0.55 | | | | | | yes | 24 ml | Formation of a |
| | | | | | | | | after 24 h | cloudy gel |
| 3* | 0.05 | | 0.568 | | | | no | | Transparent liquid |
| | | | | | | | | | after 21 d at 40° C. |
| 4* | 0 | | | 0.572 | | | no | | Transparent liquid |
| | | | | | | | | | after 21 d at 40° C. |
| 5* | 0 | | | | 0.45 | | no | | Transparent liquid |
| | | | | | | | | | after 21 d at 40° C. |
| 6* | 0 | | | | | 0.588 | no | | Transparent liquid |
| | | | | | | | | | after 21 d at 40° C. |
| 12 (control) | 0.15 | | | | | | yes | 5 ml | White precipitate |
| 13 | 0.15 | | 1.558 | | | | no | | Transparent liquid |
| | | | | | | | | | after 21 d at 40° C. |
| 14 | 0.15 | | | 1.566 | | | no | | Transparent liquid |
| | | | | | | | | | after 21 d at 40° C. |
| 7* (comparative) | 0.55 | 6.97 | | | | | yes | 7.5 ml | Clear liquid if |
| | | | | | | | | after 5 h | storage at 40° C. |
| 8* | 0.55 | | 6.212 | | | | no | | Transparent liquid |
| | | | | | | | | | after 21 d at 40° C. |

*present in the mixture before further addition of water approximately 500 ppm

As regards mixtures 3, 4, 5 and 6, the formulations remain “unchanged” (=colorless liquids without apparent evolution) and do not exhibit any significant evolution of gas over the duration of the stability test at 40° C. for 21 days.

Mixture 2, comprising more than 5000 ppm of water, for its part changes very quickly: after only a few hours at 40° C., a slightly cloudy chemical gel is observed in the closed flask. The measurement of the evolution of gas shows a strong evolution of 24 ml after 24 h at 40° C. This change corresponds to the expected reaction of the NCO functional groups with the water, resulting in the formation of CO₂.

The influence of the dehydrating agents tested is clearly demonstrated through the results obtained with the mixtures; mixture 7, comprising Incozol 2, degases after a few hours at 40° C.

Moreover, the disappearance of the water from the formulations was quantified by monitoring the level of water in formulations 13 and 14 over time by the Karl-Fischer method.

### Table V

### Kinetic Monitoring of the Consumption of Water and of NCO Functional Group of Mixtures 13 and 14

TABLE V
Kinetic monitoring of the consumption of water and of
NCO functional group of mixtures 13 and 14

| | | Mixture 12 | Mixture 13 | Mixture 14 |
|---|---|---|---|---|
| | Storage | Amount of | Amount of | Amount of |
| | temperature | water in | water in | water in |
| Duration | (° C.) | ppm | ppm | ppm |
| t₀ | 23° C. | 1500 | 1480 | 1480 |
| | 40° C. | | | |
| t = 20 min | 23° C. | | 650 | 606 |
| | 40° C. | | | |
| t = 144 h | 23° C. | | 63 | 66 |
| | 40° C. | | 56 | 19 |

It is thus clearly apparent that the 2 dehydrating agents BSA and HMDZ make it possible to consume the water present in the (poly)isocyanate formulation. In the case of mixture 14, no cloudiness or gel was formed. This result probably originates from the fact that, with the amounts of water introduced, the urea derivatives formed are not sufficient to be detected by eye.

The above examples make it possible to show that some silylated derivatives can be used effectively to dehydrate (poly)isocyanate formulations without, however, generating volatile products. The preferred compound is undeniably BistrimethylSilylAcetamide or BSA, for which no evolution of gas was detected, so long as the amount of dehydrating agent introduced is sufficient to consume the water present, and furthermore does not generate any insoluble compound.

BSU and HMDZ can also be used as dehydrating agents.

Finally, the advantage of the structures of oxazolidine type, generally used to “dry” organic media, may be noted. However, it is pointed out that the use of Incozol 2 resulted, in the presence of water, in the formation of VOCs (ketones or aldehydes) and in a chemical gel when the “drying” of the formulation is carried out at ambient temperature.

1-11. (canceled)

12. A composition comprising, for successive or simultaneous addition:
an isocyanate subcomposition comprising, by weight, at most 5%, of diisocyanate monomers and of monomers derived from amino acids and containing a content of isocyanate functional groups at most equal to 55%,
said composition additionally comprising at least one compound selected from among compounds carrying dihydrocarbylsilylene [-(Hc)₂Si—] groups, or hydrocarbyl(hydrocarbyloxy)silylene [-(Hc)(Hc-O—)Si—] group(s), attached to a semimetal of the chalcogens column of the Periodic Table or to an atom of the nitrogen column, the content of such group(s) being at least equal to 0.1‰ (by weight), expressed as weight of silicon atom (A.W.=28.1) present in a dihydrocarbylsilylene, with respect to the amount of monomers corresponding to the units which result therefrom.

13. The composition as defined by claim 12, wherein, when said semimetal is an oxygen, the latter attached to an electron-withdrawing group Ew such that Ew-OH is an acid, the pKa of which, measured in water, is at most equal to 9.

14. The composition as defined by claim 12, wherein, when said semimetal is a chalcogen —Y—, the latter attached to an electron-withdrawing group Ew such that Ew-Y—H is an acid, the pKa of which, measured in water, is at most equal to 9.

15. The composition as defined by claim 12, wherein, when said semimetal is a chalcogen —Y— and when the latter is attached to an electron-withdrawing group Ew such that Ew-Y—H is an acid, the pKa of which, measured in water, is at most equal to 8, the composition comprises a nonalkylatable organic or inorganic base capable of neutralizing said acid.

16. The composition as defined by claim 15, wherein the amount of base is at least equal, in normality, to 0.1, times the amount of dihydrocarbylsilylene, expressed as silicon atom equivalent.

17. The composition as defined by claim 15, wherein the amount of base is at most equal, in normality, to 2 times the amount of dihydrocarbylsilylene, expressed as silicon atom equivalent.

18. The composition as defined by claim 12, additionally comprising, for successive or simultaneous addition, a surface-active agent.

19. The composition as defined by claim 12, additionally comprising, for successive or simultaneous addition, a solvent.

20. The composition as defined by claim 12, additionally comprising a hygroscopic solvent (carrying a polar functional group).

21. The composition as defined by claim 12, additionally comprising, for successive or simultaneous addition, a polyfunctional subcomposition possessing mobile hydrogen.

22. An adjuvant comprising compounds carrying dihydrocarbylsilylene [-(Hc)₂Si—] groups attached to a semimetal of the chalcogens column of the Periodic Table or to an atom of the nitrogen column, the content of such groups being at least equal to 0.1‰ (by weight), expressed as weight of silicon atom (A.W.=28.1), with respect to the amount of monomers corresponding to the units which result therefrom.

23. A paint, varnish or adhesive comprising the composition as defined by claim 12.
